(19) United States
(12) Patent Application Publication
(10) Pub. No.: US 2011/0188923 A1
(43) Pub. Date: Aug. 4, 2011

(54) MULTI-AXIS ARTICULATED IMPLEMENT

(76) Inventors: Andre LAFLEUR, Boucherville (CA); Eric BUSSIERE, Sainte-Julie (CA)

(21) Appl. No.: 13/019,730

(22) Filed: Feb. 2, 2011

Related U.S. Application Data
(60) Provisional application No. 61/282,398, filed on Feb. 2, 2010.

(30) Foreign Application Priority Data
Feb. 2, 2010 (CA) 2701090

(51) Int. Cl. F16C 11/10; F16C 11/06

(52) U.S. Cl. 403/53; 403/106

(57) ABSTRACT

A lockable articulated joint comprises a first member having a ball shaped attachment further having a recess on its periphery. A rotationally symmetric conforming plunger is for movably nesting into the recess. A second member pivotally receives the ball shaped attachment and comprises a plunger holding portion. User alignment of the recess with the plunger holding portion allows configuring the joint in one of at least two selectable locked positions. The articulated joint is usable in a multi-axis articulated implement, in which one member is an elongated end effecter having a working face and the other member is an elongated handle portion. A user may configure the implement in various locked attitudes, wherein a working face's longitudinal axis extends parallel or perpendicular to the handle, or wherein the working face's normal axis extends parallel to the handle. The implement may be embodied into a multi-axis snow brush.

### TECHNICAL FIELD

The present disclosure generally relates to articulated implements and, more specifically, to a lockable articulated joint having a rotationally symmetric plunger for locking the joint in at least two positions.

### BACKGROUND

Cleaning implements such as brushes or cleaning pads are often provided with multi-axis pivotal joints connecting an end effecter to a handle to enable selective or continuous adaptation of the angular orientation of the end effecter with respect to the handle according to the job being carried out. For example, certain types of snow removal brushes for vehicles are provided with an adjustable joint allowing a user to select between two configurations of the brush, e.g. a “T” configuration wherein the elongated end effecter lies perpendicularly to the handle axis, or a linear configuration wherein the end effecter is co-extending along the handle axis. According to some concepts, a plurality of discrete lockable positions is provided about a given axis of rotation.

For example, U.S. Pat. No. 6,625,837 (Jiang—September 2003) discloses a cleaning brush comprising an angle adjuster which enables lockable rotation of the elongated end effecter about a single axis perpendicular to the handle but generally parallel to the bristles' orientation. Some other examples of single axis pivotal joint cleaning implements have been taught, such as U.S. Pat. Nos. 2,280,165 (Sebastian—April 1942), 6,128,800 (Vosbikian—October 2000), 6,990,705 (Schouten—January 2006), and US patent application No 2004/0250365 by Anderson et al.

However, in conventional snow removal implements, end effecter's bristles (i.e. the efficient face normal axis) extend substantially perpendicular to the handle axis, regardless of the selected configuration. Obviously, this limitation prevents the user from performing certain tasks which require the bristles to extend along the handle axis as a prolongation thereof, substantially in a common plane, such as in a broom. Although some existing cleaning implements comprise a multi-axis swiveling joint connection of the universal joint type to continuously adapt to performed job changing effecter orientation requirements, such solutions do not provide the level of effecter control needed in performing many tasks which require transmission of working forces from the handle to the effecter through a rigid coupling joint. This is namely exemplified from U.S. Pat. No. 5,551,115 (Newville—September 1996) showing a ball and socket brush head connection freely pivoting about two orthogonal axes, and in U.S. Pat. No. 4,763,377 (Madsen—August 1988) teaching a swiveling scrub brush structure featuring adjustable friction swivel movement about two orthogonal axes, without enabling quick changeover between user selectable predetermined lockable configurations.

### SUMMARY

A lockable articulated joint capable of locking into multiple positions would be usable in a wide variety of applications. One such application would bring a significant advance in the art of cleaning implements, such as snow brushes, as well as in other types of implements in which an end effecter is connected to a handle, to provide a multi-axis user selectable articulation joint for improved flexibility and performance. The present disclosure provides a user selectable articulated joint implement obviating the limitations and drawbacks of earlier devices.

In a first aspect of the present disclosure, a lockable articulated joint comprises a first member, a conforming plunger, and a second member. The first member has a ball shaped attachment, with a recess provided about a periphery of the ball. The plunger is adapted for movable nesting into the recess, the plunger having a non-circular, rotationally symmetric shape. The second member is adapted to pivotally receive the ball shaped attachment and comprises a plunger holding portion. User selectable alignment of the recess with the plunger holding portion allows configuring the lockable articulated joint in one of at least two selectable locked positions.

In a second aspect of the present disclosure, a multi-axis articulated implement comprises an elongated end effecter, at least one conforming plunger, and an elongated handle portion. The elongated end effecter has a working face defining a longitudinal axis and a normal axis, and a ball shaped attachment having a plurality of recesses provided about its periphery. The at least one conforming plunger is adapted for movable nesting into at least one of said recesses. The elongated handle portion defines a proximal end and a distal end portion adapted to pivotally receive the ball attachment. The elongated handle portion also comprises at least one plunger holding portion. User selectable alignment of at least one of the plurality of recesses with the at least one plunger holding portion configures the implement in one of three locked attitudes. These comprise a first locked attitude, in which the working face's longitudinal axis is extending substantially parallel to the handle, a second locked attitude, in which the working face's longitudinal axis extends substantially perpendicular to the handle, and a third locked attitude, in which the working face's normal axis extends substantially parallel to the handle.

In a third aspect of the present disclosure, a lockable articulated joint comprises a first member and a second member. The first member has a ball shaped attachment, a ridge being provided about a periphery of the ball. The ridge has a non-circular, rotationally symmetric shape. The second member is adapted to pivotally receive the ball shaped attachment and comprises a conforming recess adapted for nesting of the ridge. User selectable alignment of the conforming recess with the ridge allows configuring the lockable articulated joint in one of at least two selectable locked positions.

The foregoing and other features will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1a is a perspective view of an example of multi-axis articulated implement representing an extensible snow brush;

FIG. 1b is a top plan view of the multi-axis articulated implement of FIG. 1a;

FIG. 1c is a side elevation view of multi-axis articulated implement of FIG. 1a;

FIG. 1d is a front elevation view of the multi-axis articulated implement of FIG. 1a;

FIG. 2a is a perspective view of the multi-axis articulated implement of FIG. 1a, shown in a first configuration;

FIG. 2b is perspective view of multi-axis articulated implement of FIG. 1a, shown in a second configuration;

FIG. 2c is a perspective view of multi-axis articulated implement of FIG. 1a, shown in a third configuration;

FIG. 3a is a perspective exploded view of a distal portion of the implement of FIG. 1a, showing internal details of a multi-axis lockable articulated joint in a first position;

FIG. 3b is a perspective exploded view of the distal portion of the implement of FIG. 1a, showing internal details of the multi-axis lockable articulated joint in a second position;

FIG. 3c is a perspective exploded view of the distal portion of the implement of FIG. 1a, showing internal details of the multi-axis lockable articulated joint in a third position;

FIG. 4 is a perspective exploded view of the distal portion of the implement, in the second configuration of FIG. 2b, showing internal details of the multi-axis lockable articulated joint according to an embodiment;

FIG. 5 shows a variety of plunger shapes that may be used in a lockable articulated joint;

FIG. 6 is a perspective exploded view of the distal portion of the implement, in the second configuration of FIG. 2b, showing internal details of a multi-axis lockable articulated joint according to another embodiment;

FIG. 7 is a perspective exploded view of the distal portion of the implement, in the second configuration of FIG. 2b, showing internal details of a multi-axis lockable articulated joint according to a further embodiment;

FIG. 8 is a perspective exploded view of another example of extensible snow brush according to an embodiment of the present disclosure, showing details of the extensible handle; and

FIG. 9 is a perspective exploded view of the distal portion of the implement, in the second configuration of FIG. 2b, showing internal details of the multi-axis lockable articulated joint according to a variation.

Similar parts are represented by identical numerals throughout the drawings and description.

### DETAILED DESCRIPTION

A lockable articulated joint of the present disclosure, capable of being locked in at least two positions, may be embodied into a wide range of implements comprising end effecters of different types adapted to different tasks.

More specifically, an embodiment comprises a multi-axis articulated implement comprising i) an elongated end effecter having a working face defining a longitudinal axis and a normal axis, and a ball shaped attachment having a plurality of recesses provided about its periphery, ii) at least one conforming plunger adapted for movable nesting into at least one of said recesses, and iii) an elongated handle portion defining a proximal end and a distal end portion adapted to pivotally receive said ball attachment and comprising at least one plunger holding portion. Thereby, a user may selectively configure the implement in at least a first locked attitude wherein the working face's longitudinal axis is extending substantially parallel to the handle, a second locked attitude wherein the working face's longitudinal axis extends substantially perpendicular to the handle, or a third locked attitude wherein the working face's normal axis extends substantially parallel to the handle, by operating proper alignment of at least one of the recesses with the at least one plunger holding portion.

Another embodiment comprises a multi-axis articulated implement comprising i) an elongated end effecter having a working face defining a longitudinal axis and a normal axis, and a ball shaped attachment having at least first and second plunger receiving recesses provided along a common latitudinal line of the ball, ii) at least first and second plungers respectively conforming to said first and second recesses and movably nested therein, and iii) an elongated handle portion defining a proximal end and a distal end portion adapted to pivotally receive said ball attachment and defining at least one opening having a plunger receiving portion, whereby a user may selectively configure the implement in a first locked attitude wherein the working face's longitudinal axis is extending substantially parallel to the handle by registering the first plunger with the opening, a second locked position wherein the working face's longitudinal axis extends substantially perpendicular to the handle by registering the second plunger with the opening with a first relative orientation, or in a third locked attitude wherein the working face's normal axis extends substantially parallel to the handle by registering the second plunger with the opening with a second relative orientation.

In an embodiment, the multi-axis articulated implement may further comprise at least one plunger biasing device such as a compression spring to bias each plunger in an extended attitude. Springs may be mounted in each recess behind a plunger to urge said plunger away from the recess.

According to another embodiment, the multi-axis articulated implement may further comprise a release press button movably mounted into an outer portion of said opening for applying a force on a plunger engaged in the plunger receiving portion of the opening to compress the biasing device and retract said plunger further into the recess and thereby unlock the end effecter and enable movement thereof.

In a further embodiment, the plungers and the plunger receiving portion of the opening may adopt a geometric shape defining four 90° apart lockable relative positions. The shape may define a cross, a square shape, a four branch star, and the like.

In another embodiment, the plungers may be provided with rounded (beveled) edges to ease engagement with the receiving portion of the opening, but sharp enough to maintain lock position.

In a still further embodiment, the ball shaped attachment may further comprise third and fourth plunger receiving recesses and third and fourth matching nested plungers equally distributed along with the first and second recesses on the common latitudinal line. In an embodiment, the latitudinal line may be the equatorial line.

In an embodiment particularly addressing the need for snow removal, the working face may be provided with bristles projecting generally in the direction of a normal axis thereof to define a brush.

Cleaning of vertical surfaces of a vehicle may be carried out with an implement configurable such that bristles extend along a handle axis, as a prolongation thereof, substantially in a common plane with the handle axis, as in the case of a straight broom. The present disclosure provides a combination of selectable implement configurations enabled through rotation of the end effecter about either one of two orthogonal axes defining a plane perpendicular to the handle axis.

Although a snow removal brush will be described in the following, as an illustrative embodiment of the disclosure, it should be understood that the disclosed articulated joint may be used in various other applications. Non-limiting examples of uses of the lockable articulated joint include various types of tool holders, frame holders, display holders, ergonomic apparatuses, and the like. The exemplary embodiments of a snow removal brush are therefore not meant to limit the present disclosure.

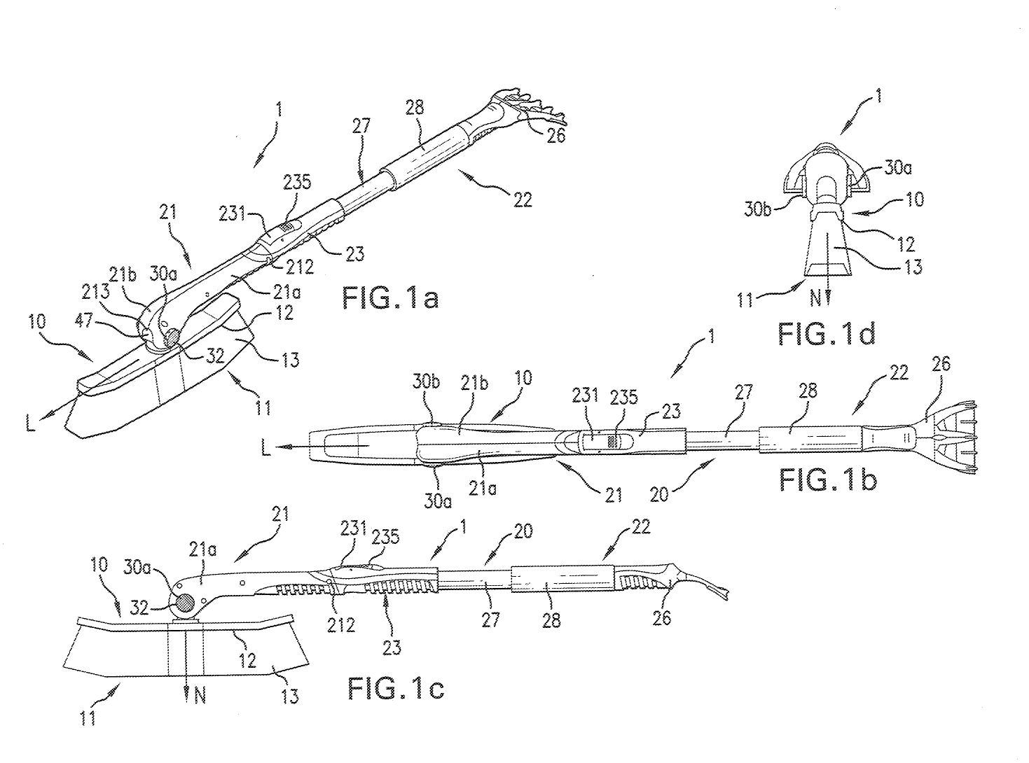

FIGS. 1a to 1c are, respectively, a perspective view, a top plan view and a side elevation view of an example of multi-axis articulated implement representing an extensible snow brush. A snow brush, which in the present example is extensible, comprises a multi-axis articulated hand implement 1 provided with a multi-axis joint connecting an elongated end effecter 10, for example a brush, to a distal end portion 21 of an elongated extensible handle 20, also defining a proximal end 22 and a length adjusting device 23 to adjust the distance between the distal end and the proximal end.

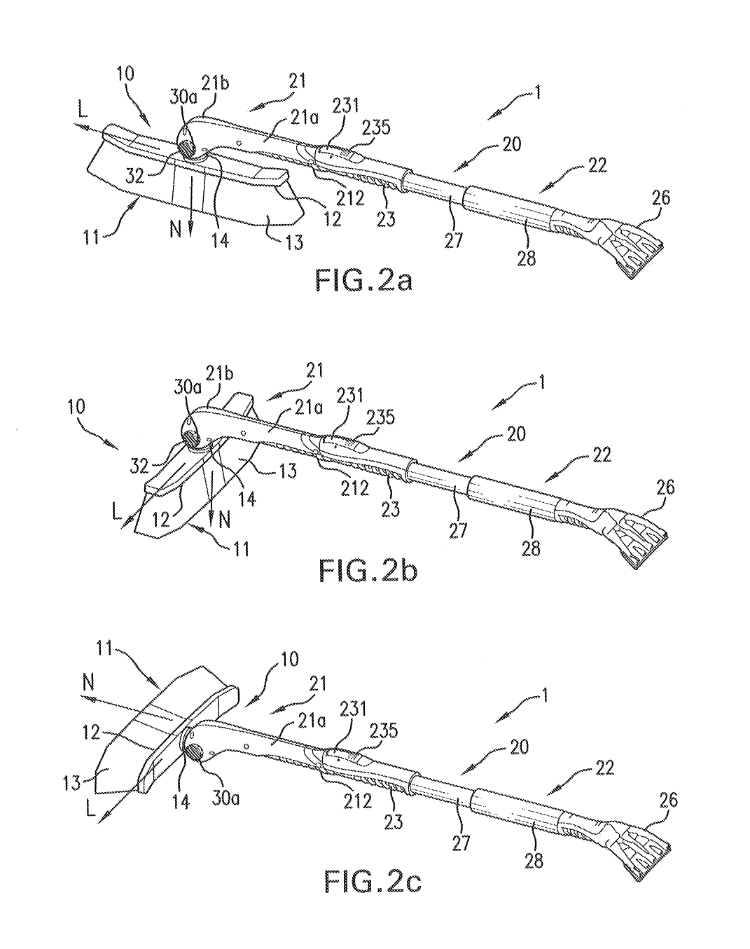

The end effecter 10 defines a working face 11 defining a longitudinal axis L and a normal axis N, and a base surface 12 populated with brush bristles 13 projecting therefrom generally in the direction of the normal axis N. The orientation of the end effecter 10 with respect to the handle 20 may be changed to enable a plurality of brush configurations as illustrated in FIGS. 2a to 2c, which are perspective views of the multi-axis articulated implement of FIG. 1a shown, respectively, in a first, second and third configuration. Release push buttons 30a and 30b are used to unlock the multi-axis joint and perform the reorientation of the end effecter 10.

As shown in FIGS. 2a to 2c, the end effecter 10 of the hand implement 1 may be configured in either of three attitudes with respect to the handle 20. Firstly, as illustrated in FIG. 2a, the end effecter 10 may be set with its longitudinal axis L extending generally parallel to the longitudinal axis of handle 20 and the normal axis N and bristles 13 projecting generally orthogonal to the handle axis. Secondly, the implement end effecter 10 may be set so that its longitudinal axis L extends generally perpendicular to the handle axis as illustrated in FIG. 2b, the normal axis N and bristles 13 still projecting generally orthogonal to the handle axis. Thirdly, the end effecter 10 may be so oriented that the normal axis N and the bristles 13 project generally parallel to the handle's longitudinal axis, and the axis L lies orthogonal and substantially in the same plane as the handle axis, to adopt a substantially coplanar broom like configuration as illustrated in FIG. 2c.

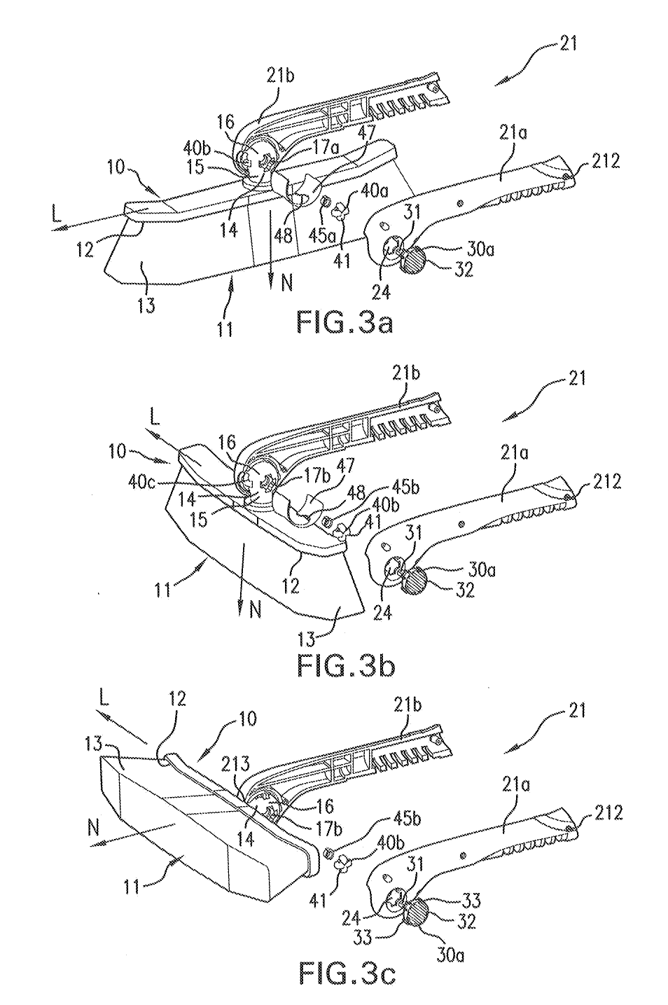

Turning now to FIGS. 3a to 3c, which are perspective exploded views of a distal portion of the implement of FIG. 1a, showing internal details of a multi-axis lockable articulated joint in, respectively, a first, second and third position, a first embodiment of the multi-axis lockable articulated joint will be described in details. A ball shaped attachment 14 defining a neck portion 15 and a ball portion 16 projects from a top surface of the end effecter 10. The ball 16 is provided with a first recess 17a for receiving a first conforming plunger 40a and a second recess 17b for receiving a second conforming plunger 40b.

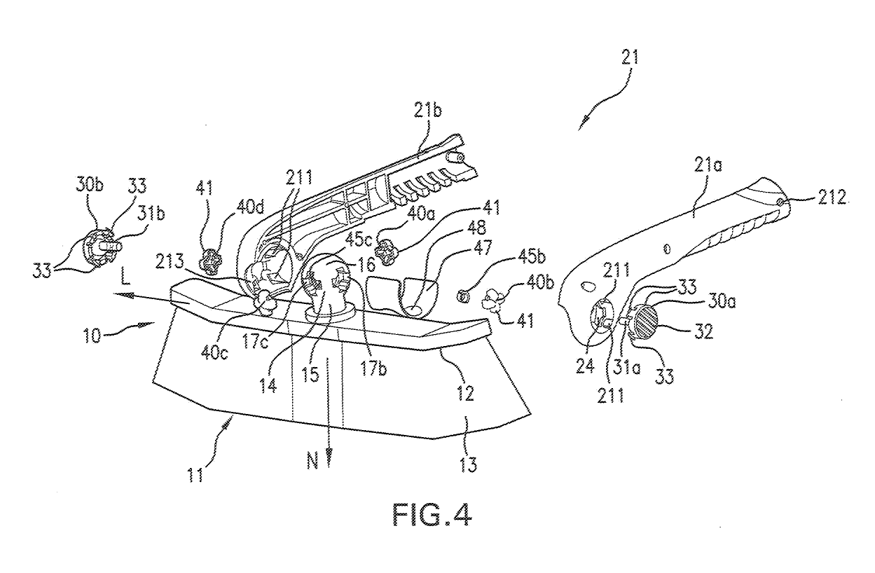

Although only two recess/plunger sets are visible on FIGS. 3a-c, four orthogonal sets may be provided as best viewed from FIG. 4, which is a perspective exploded view of the distal portion of the implement, in the second configuration of FIG. 2b, showing internal details of the multi-axis lockable articulated joint according to an embodiment. The four orthogonal recess/plunger sets enable continuous rotation of the end effecter in one direction in a plane, with locking positions every 90°, and superior locking and general mechanical strength. However, it is contemplated that a functional implement 1 according to the disclosure may be comprised of only two recess/plunger sets 90° apart on the equatorial line of the ball 16. In such a case, only one push button 30 is required to set the end effecter 10 parallel (FIG. 2a) or perpendicular (FIG. 2b) to the handle axis, but only two angular stops of the end effecter would be enabled.

The description will now proceed with reference to a four plunger embodiment of the disclosure. As seen from FIG. 4, ball 16 accordingly comprises four recesses 17 (17b and 17c shown) positioned 90° apart along the same equatorial line, to provide four 90° apart stop positions around the circumference of ball 16. Therefore, four plungers 40a to 40d are movably nested in their respective recess, being outwardly biased by a compression spring such as 45a. Two openings 24a and 24b as well as two push buttons 30a and 30b are provided on respective halves 21a and 21b of the distal end portion 21. Each opening 24 forms a plunger holding portion. The openings 24a and 24b each comprise an inner portion so sized and shaped to receive and hold the portion of a plunger 40a-40d protruding from the surface of the ball 16 of attachment 14 to lock the end effecter 10 in one of the predetermined positions.

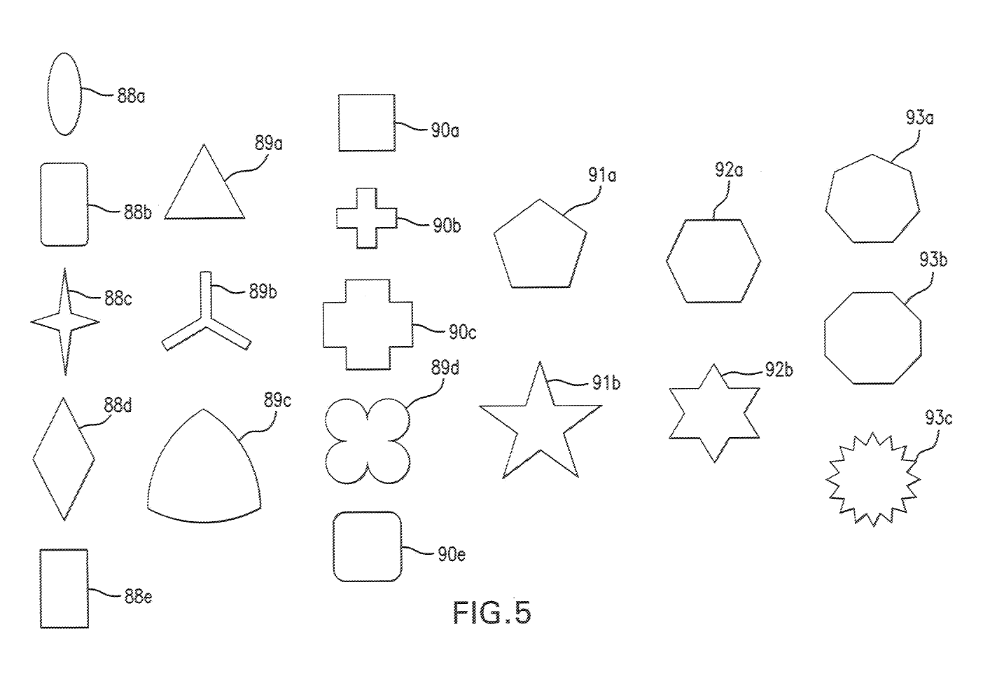

In the embodiment shown, the plungers 40a-40d are given a cross shape in order to enable insertion in four 90° apart angular positions into each opening 24a, 24b. Alternatively, a square plunger section may be contemplated for similar results and other shapes such as an eight branch star could be contemplated to enable indexing to 45° apart locking positions or other desired end effecter pivoting options. FIG. 5 shows a variety of plunger shapes that may be used in a lockable articulated joint. A geometric shape of the plunger is non-circular and is rotationally symmetric, in the sense that the shape is substantially identical to itself when rotated by 180 degrees or less, allowing for minor variations due for example to manufacturing tolerances. For example, a plunger having any of the shapes 88a to 88e may allow the articulated joint to lock into two (2) opposite positions, following a 180-degree rotation. A plunger having any of shapes 89a to 89c may allow the articulated joint to lock in three (3) positions separated by a 120 degree angle. Shapes 90a to 90e allow four (4) distinct positions at right angles. Shapes 91a and 91b allow five (5) distinct positions, shapes 92a and 92b allow six (6) distinct positions and shapes 93a to 93c allow locking of the articulated joint at higher numbers of positions. In fact, any one of an oval, a rectangle, a lozenge, an equilateral triangle, a reuleaux triangle, a square, a cross having identical arms, a regular polygon or a star having at least three identical branches may form a suitable plunger shape, this list being non-limiting. It is therefore possible to use plungers and matching recesses offering a large number of positions, using for example shape 93c. Of course, the various shapes shown on FIG. 5 are non-limiting and those of ordinary skill in the art will be able to select various other suitable shapes. In FIGS. 3a-3c and 4, the recesses 17, the plungers 40 and the openings 24 all share a similar cross shape. A variation may comprise, for example, rectangular recesses and rectangular plungers, having the shape as shown at item 88e of FIG. 5, along with a plunger holding portion having a cross-shaped opening, as shown at item 90c of FIG. 5. Such a combination also allows locking of the articulated joint in four 90° apart angular positions. In this particular case, a plunger shaped as 88e, being symmetrical along one axis, may connect with an opening that is symmetrical along two axes, being shaped as 90c. Other combinations may also be contemplated, in which a plunger is capable of matching a recess for locking the articulated joint in at least two angular positions. A lockable articulated joint using any of the various rotationally symmetric shapes described herein may comprise a release mechanism such as the release push buttons 30a and/or 30b, shown on the preceding Figures, or any other release mechanism described herein.

The end effecter 10 and the distal end portion 21, as shown for example on FIG. 4, may, for various applications, be substituted by other elements. A lockable articulated joint may be advantageously used in a wide variety of contexts. A ball, similar to the ball 16, may therefore be attached to, connected to, or made integral with a first member. A second member may be adapted to pivotally receive the ball. One of the first or second members may be attached to a fixed location, such as a wall, a floor, a machine, a piece of furniture, and the like. Another of these members, or both members, may be attached to movable devices, such as a tool. Both members may be part of a same device, such as for example a table lamp having a configurable shape and orientation. Regardless of its use, the lockable articulated joint comprises, in addition to the first and second members, one or more rotationally symmetric conforming plungers adapted for movable nesting into the recess. As expressed hereinabove, the one or more plungers have a non-circular shape that is substantially identical to their shape rotated by 180 degrees or less. The second member comprises at least one plunger holding portion. A user of the articulated joint may change configuration of the joint by moving the first member in relation to the second member until at least one of the plungers is aligned with at least one of the plunger holding portions. At least because of the shape of the plunger(s), the articulated joint may be locked in at least two possible positions. If the articulated joint comprises more than one plunger, one or more of the plungers may align with any one of the one or more plunger holding portions.

On the preceding Figures, the plungers 40a-40d are all present on a same equatorial line, sharing a same plane with a center (not shown) of the ball 16. In other embodiments, a number of plungers may be positioned at various places on a ball. For example, a first plunger and a second plunger may form a plane with the center of the ball while a third plunger may be outside of that plane. The first and the second plunger may form a right angle with the center of the ball, or may form other angles, depending on an intended use of the lockable joint. Likewise, a third plunger may be at a normal position from the plane formed by the first and second plungers and the center of the ball. The third plunger, if present, may alternatively be located elsewhere on the periphery of the ball.

In yet other embodiments, a number of plunger holding portions may be positioned at various places on a part of the second member that pivotally receives the ball. For example, a first plunger holding portion and a second plunger holding portion may form a plane with the center of the ball, when the ball is received in the second member, while a third plunger holding portion may be outside of that plane. The first and the second plunger holding portions may form a right angle with the center of the ball, or may form other angles, depending on an intended use of the lockable joint. Likewise, a third plunger holding portion may be at a normal position from the plane formed by the first and second plunger holding portions and the center of the ball. The third plunger holding portion, if present, may alternatively be located elsewhere along the periphery of the ball.

Some applications may require an articulated joint that locks in various positions while also allowing positioning in non-locked positions. Those of ordinary skill in the art will readily be able to make proper selection of numbers, shapes and locations of plungers and plunger holding portions to meet such needs.

From the above, those of ordinary skill in the art will readily appreciate that a lockable articulated joint built according to the present disclosure may lock in a wide variety of positions, and may further be placed in a non-locked position. The first and second members of the lockable articulated joint may be attached to a broad variety of devices, one or both of the members being possibly attached to a device having a permanent fixed position, such as a wall, a floor, furniture, or the like. Therefore the embodiments of the multi-axis articulated hand implement 1 of the preceding Figures, showing cross-shaped plungers 40a-40d and recesses mounted on a single, equatorial line of the ball 16, for use as a snow cleaning implement, should be understood as exemplary are not meant to limit the present disclosure.

Returning to FIG. 4, two plungers inserted in openings 24a and 24b are blocking rotation of the end effecter 10 in each of the three (3) selectable positions thereof for high mechanical resistance and stability. Accordingly, unlocking of the multi-axis joint and repositioning of the end effecter may be accomplished by pressing release push buttons 30a and 30b simultaneously, using for example the thumb and the index of one hand.

The release push buttons 30a and 30b are snap fitted into openings 211 and held by their peripheral wings 33 while remaining axially movable into the opening 24. Each push button 30a, 30b comprises a stem portion 31a, 31b having a tip abutting on the protruding surface of a plunger such as 40a, so that an axial pressure applied at the button outer face 32 causes the spring 45a to become further compressed, allowing the plunger 40a to be urged inwardly into recess 17a, thereby at least partially clearing the opening 24. Since the plungers 40a-40d are provided with beveled rounded edges 41 at their perimeter, smooth transition is enabled between angular positions or insertion/extraction motions of the plungers in/from the opening 24. Therefore, even with partial extraction of a plunger 40 from an opening 24, a slight torque applied on the end effecter 10 in the direction of the desired movement creates a force transferred from the opening edges to the plunger edges, in turn creating an axial force component on the plunger and on the spring 45 to fully extract the plunger from the opening 24 thus enabling moving to another configuration. However, the edges 41 are made sharp enough to provide proper locking when a plunger 40 is fully inserted in an opening 24.

In some embodiments, this characteristic may be exploited to enable position indexing without the help of any release push button 30, provided the plunger edges 41 and spring properties are designed to enable unlocking and position indexing by merely applying a reasonable torque on the end effecter 10. Careful design may balance a limit of a strain that may be applied to the end effecter in use, without causing undesired position unlocking.

In order to allow the end effecter to be movable from the position illustrated in FIG. 3b to that illustrated in FIG. 3c, an elongated slot 213 having a width slightly wider than the diameter of the neck 15 of attachment 14 is provided through the surface of the distal end portion 21 of the handle 20. A flexible sealing member 47 provided with a key hole 48 for insertion about attachment neck 15 is thus mounted to slide in the articulated joint recess and continuously seal the portion of the slot 213 surrounding the attachment 14 to preserve inner joint components from outside contaminants such as snow and ice.

In use, a user may change the implement 1 from a configuration to another by first grasping handle distal portion 21 and simultaneously pressing the surface 32 of the release push buttons 30a and 30b with one hand and maintaining the buttons in a depressed position to push the plungers 40 inwardly and thereby extract them from the openings 24a and 24b, then moving the end effecter 10 out of its current position with his second hand, and then releasing both push buttons 30a, 30b to allow the registered plungers 40 to extend and engage into the openings 24a, 24b respectively and thereby lock the end effecter into any other selectable position to yield the desired implement configuration.

For example, to pass from the first longitudinal position illustrated in FIGS. 1a, 2a and 3a to the second transversal position illustrated in FIGS. 2b, 3b and 4, after pressing the release buttons, the end effecter 10 is pivoted in any direction about the attachment axis to extract plungers 40a and 40d from the openings 24a, 24b and bring plungers 40b and 40c in register with the openings. To pass from that second position to the coplanar broom like third configuration illustrated in FIGS. 2c and 3c, the end effecter 10 is rotated about the buttons axis in the clockwise direction, according to that view, so that the plungers 40b and 40d will be extracted from openings, rotated by 90° and reinserted into the conforming openings.

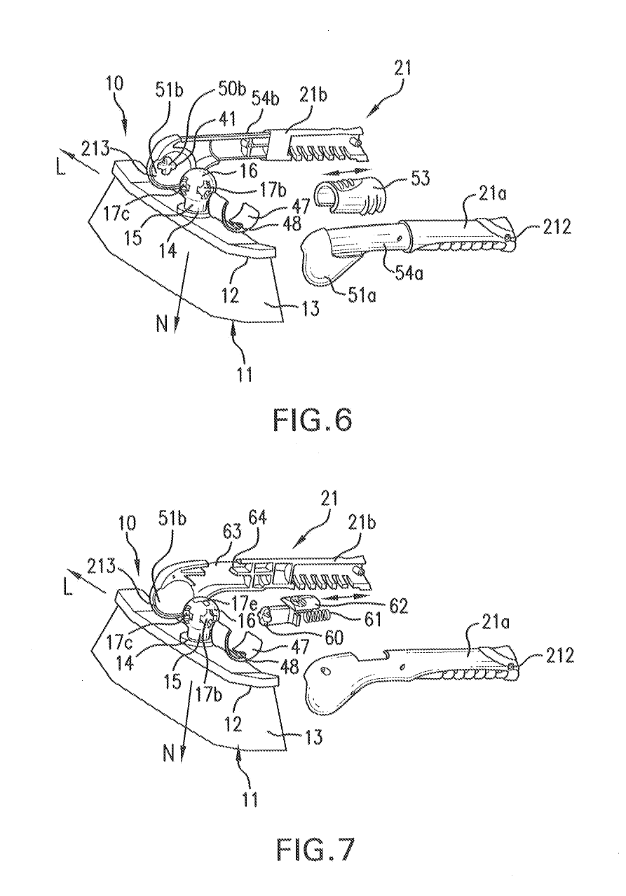

Referring now to FIGS. 6 and 7, which are perspective exploded views of the distal portion of the implement, in the second configuration of FIG. 2b, showing internal details of a multi-axis lockable articulated joint according to two distinct embodiments, alternative embodiments of the multi-axis lockable articulated joint of the end effecter 10 of the implement 1 will be described. Ridges or plungers projecting from the distal end portion 21 selectively engage the recesses to provide the locking action.

As shown on FIGS. 3a-3c, and 4, the plungers 40a-40d are free floating, in the sense that they are not permanently connected in a fixed position to other components of the multi-axis articulated hand implement 1. In those embodiments, pushing the plungers 40a-40d into corresponding recesses 17a-17d enables rotation of the distal end portion 21 around the ball 16, unlocking the implement 1. Other embodiments will now be presented, in which plungers are not free-floating, but rather attached to or maintained by elements that are external to the ball 16, these elements doubling as plunger holding portions. In those embodiments, pushing these plungers into the ball has the effect of locking the implement 1. In FIG. 6, an embodiment of the multi-axis joint in provided, wherein the free-floating plungers 40a-40d and the matching openings 24a and 24b are replaced by cross shaped ridges 50a and 50b molded into the internal face of the shells 51a and 51b of the distal end portions 21a and 21b. The ridges 50a and 50b form plungers of a distinct type, when compared to the plungers 40a-40d, but still provide similar locking and unlocking functions. The internal face of the shells 51a and 51b act as plunger holding portions. Sleeve 53 sliding on neck portions 54a of 21a and 54b of 21b replaces the push buttons 30a and 30b as the actuating means. Thereby, sliding sleeve 53 away from the end effecter 10 enables rotation thereof by enabling shells 51a and 51b to move away from each other. Reciprocally, sliding the sleeve toward the end effecter 10 urges the shells closer to each other, forcing the ridges 50a and 50b into the recesses 17 of the ball 16 to lock the end effecter in a selected position. Moreover, a lock means (not shown) for maintaining the sleeve 53 in the locking position may be provided. As expressed hereinabove, rectangular shaped ridges 50a and 50b and matching cross shaped openings recesses 17a-d may be used in a variation to the embodiment of FIG. 6, allowing locking the multi-axis joint in the same configurations.

As in the case of the embodiment of FIG. 6, a non-free-floating plunger is used in the embodiment of FIG. 7. In this embodiment, a single manually activated plunger 60 forwardly biased against ball 16 by spring 61, which abuts against a seat 64 within the distal end portion 21, is slidably mounted into a compartment (plunger holding portion) of distal end portion 21 for reciprocating displacement therein. The plunger 60 comprises a thumb friction actuation tab 62 emerging from the distal portion 21 through slot 63, the friction actuation tab enabling manual displacement of the plunger 60 in or out of engagement with any one of the recesses 17a-d of the ball 16. According to the position of the plunger, a fifth recess 17e is provided at the apex, of the ball 16 to enable locking of the end effecter 10 in the broom-like coplanar position, the working face normal axis N being substantially parallel to the longitudinal axis of the handle 20. In a variation, the plunger 60 may have a rectangular shape, capable of being inserted into each of the recesses 17a-e in two perpendicular positions.

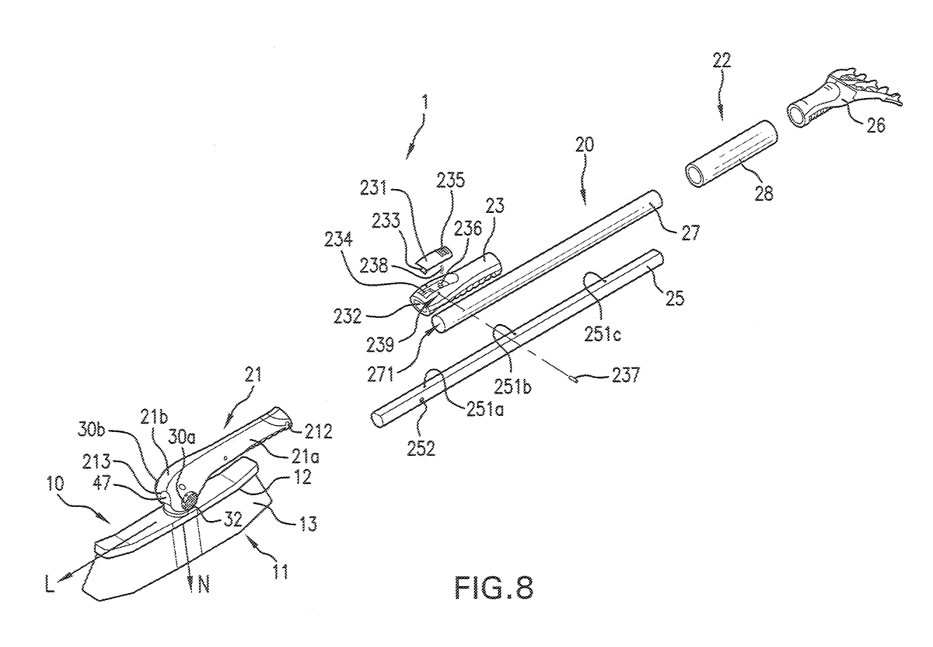

Referring now to FIG. 8, which is a perspective exploded view of another example of extensible snow brush according to an embodiment of the present disclosure, showing details of the extensible handle, the implement 1 is illustrated with an exploded adjustable length handle 20 to show the details thereof. A first rigid tubular member 25, provided with axially spaced through holes 251a-c, is assembled to the distal end portion 21 by attaching a fastener such as a rivet through aligned holes such as 212 and 252. At the proximal end 22 of the handle, a scraper 26 is similarly assembled to the proximal end of a rigid tubular sleeve member 27, which is then covered by a soft handle gripping sleeve 28. A tubular length adjusting coupling device 23 is assembled at the distal end of the sleeve 27. The inner bore 271 of the tubular member 27 as well as the internal bore 232 of the coupling device 23 are adapted to enable smooth sliding of the tubular member 25 therein to provide a locking adjustable length extensible tubular handle.

Locking of the handle 20 at different length positions is enabled by insertion of a locking stud 233 projecting from below an operating member 231 and reaching the outer surface and the mating holes 251a-c of the rigid tubular member 25 through the opening 234. The operating member 231 is rocking about a pivot (not shown) and comprises a friction portion 235 outwardly biased by a resilient member, such as compression coil spring 238 held on the seat 236, to urge the stud 233 into any of the holes 251a-c. The friction portion 235 may be pushed downwardly to compress the spring 238 and extract the stud from the current hole 251. The relative axial position of the members 25 and 27 may then be changed by sliding the coupling device 23 over the member 25. Release of the friction portion 235 of the operating member 231 then enables engagement of the stud into a different hole 251 to configure the handle 20 to a different length.

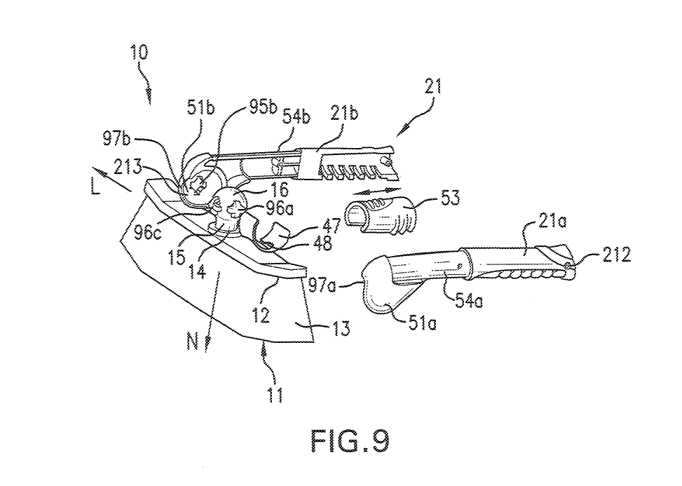

FIG. 9 is a perspective exploded view of the distal portion of the implement, in the second configuration of FIG. 2b, showing internal details of the multi-axis lockable articulated joint according to a variation. This embodiment is most easily described by highlighting its distinctions from the embodiment of FIG. 6. Ridges 50a and 50b, molded into the internal face of the shells 51a and 51b of the distal end portion 20 of FIG. 6, are replaced in FIG. 9 by recesses 95a-b cut into the shells 51a and 51b. The recess 95a cut into the shell 51a is not shown due to the perspective of FIG. 9. The recesses 95a-b are conforming to ridges 96a-d built on the periphery of the ball 16 so that the ridges 96a-d are capable of nesting into the recesses 95a-b. The ridges 96a-d have a non-circular, rotationally symmetric shape. Other elements of the multi-axis joint of FIG. 6 may remain unchanged, as shown on FIG. 9. Operation of the sleeve 53 enables the shells 51a and 51b to move away from each other or to be brought again close to each other, unlocking and then locking the joint. A front opening formed to two halves 97a and 97b on the distal end 21 allows moving the shells 51a and 51b together while providing clearance for one of the ridges 96a-d, for example ridge 96c in the configuration of FIG. 9. Embodiments of a lockable articulated joint may comprise a single ridge 96 on the ball 16 and a single conforming recess 95, the rotational symmetry of the ridge 96 allowing locking of the joint in at least two selectable positions. Other embodiments may comprise a plurality of ridges 96 and a single conforming recess 95, or a single ridge 96 with a plurality of conforming recesses 95. Yet other embodiments may comprise a plurality of ridges 96 and a plurality of conforming recesses 95, as shown on FIG. 9. The ridges 96 may have beveled rounded edges, allowing unlocking the articulated joint by application of a moderate torque. It may readily be appreciated that the embodiments of FIGS. 6 and 9 operate similarly and that a simple matter of design choice may lead those of ordinary skill in the art to select one over the other. Of course, at least some of the previously shown embodiments of the lockable articulated joint may be modified, as in FIG. 9, by replacing the recesses, plungers and plunger holding portions of the previous Figures with ridges 96a-d and conforming recesses 95a-b as shown on FIG. 9.

One may thus easily appreciate that the above described embodiments of the multi-axis articulated implement according to the present disclosure obviate the limitations and drawbacks of earlier devices, namely by providing selectable orientation of the end effecter working surface normal plane (formed by the end effecter longitudinal axis and the working surface normal axis) in a plurality of positively lockable positions according to three orthogonal configuration modes to provide maximal working versatility. For example, the implement may be embodied into a multi-axis articulated extensible snow brush that may be used for conveniently and ergonomically removing snow or debris from differently oriented surfaces. Furthermore, the implement 1 may be easily operated by a user, especially when mittens are being worn, hindering manual dexterity.

Although the present disclosure has been described hereinabove by way of non-restrictive, illustrative embodiments thereof, these embodiments can be modified at will within the scope of the appended claims without departing from the spirit and nature of the present disclosure.

What is claimed is:

1. A lockable articulated joint comprising:
a first member having a ball shaped attachment, a recess being provided about a periphery of the ball;
a conforming plunger adapted for movable nesting into the recess, the plunger having a non-circular, rotationally symmetric shape; and
a second member adapted to pivotally receive the ball shaped attachment and comprising a plunger holding portion;
whereby user selectable alignment of the recess with the plunger holding portion is for configuring the lockable articulated joint in one of at least two selectable locked positions.

2. The lockable articulated joint of claim 1, comprising:
a plurality of recesses provided about the periphery of the ball; and
a plurality of conforming plungers for movable nesting into the plurality of recesses;
whereby alignment of one of the plurality of recesses with the plunger holding portion is for configuring the lockable articulated joint in one of a plurality of selectable locked positions.

3. The lockable articulated joint of claim 2, comprising:
three recesses, a third recess being outside of a plane formed by a first recess, a second recess and a center of the ball.

4. The lockable articulated joint of claim 3, wherein:
the first recess and the second recess form a right angle with the center of the ball.

5. The lockable articulated joint of claim 4, wherein:
the third recess is at a right angle from the plane formed by the first recess, the second recess and the center of the ball.

6. The lockable articulated joint of claim 1, comprising:
a plurality of plunger holding portions provided on the second member;
whereby alignment of the recess with one of the plurality of plunger holding portions is for configuring the lockable articulated joint in one of a plurality of selectable locked positions.

7. The lockable articulated joint of claim 6, comprising:
three plunger holding portions, a third plunger holding portion being outside of a plane formed by a first plunger holding portion, a second plunger holding portion and a center of the ball when ball is received in the second member.

8. The lockable articulated joint of claim 7, wherein:
the first plunger holding portion and the second plunger holding portion form a right angle with the center of the ball.

9. The lockable articulated joint of claim 8, wherein:
the third plunger holding portion is at a normal position from the plane formed by the first plunger holding portion, the second plunger holding portion and the center of the ball.

10. The lockable articulated joint of claim 1, comprising:
a plurality of recesses provided about the periphery of the ball;
a plurality of conforming plungers for movable nesting into the plurality of recesses; and
a plurality plunger holding portions provided on the second member;
whereby alignment of one of the plurality of recesses with one of the plurality of plunger holding portions is for configuring the lockable articulated joint in one of a plurality of selectable locked positions.

11. The lockable articulated joint of claim 1, wherein:
the first member and the second member are orientable in a plurality of non-lockable positions.

12. The lockable articulated joint of claim 1, comprising:
a spring located in the recess for applying a force on the plunger.

13. The lockable articulated joint of claim 12, wherein:
the plunger has beveled rounded edges;
whereby applying a torque between the first member and the second member is for moving the lockable articulated joint out of the locked position.

14. The lockable articulated joint of claim 12, comprising:
a user depressible button for overcoming the spring force and for moving the lockable articulated joint out of the locked position.

15. The lockable articulated joint of claim 1, wherein:
the shape of the plunger is selected from the group consisting of a star having at least three identical branches, a rectangle, a lozenge, an equilateral triangle, a reuleaux triangle, a square, a cross, a regular polygon and an oval.

16. A multi-axis articulated implement comprising: i) an elongated end effecter having:
a working face defining a longitudinal axis and a normal axis, and
a ball shaped attachment having a plurality of recesses provided about its periphery;
ii) at least one conforming plunger adapted for movable nesting into at least one of said recesses; and
iii) an elongated handle portion defining a proximal end and a distal end portion adapted to pivotally receive said ball attachment and comprising at least one plunger holding portion;
whereby user selectable alignment of at least one of the plurality of recesses with the at least one plunger holding portion is for configuring the implement in:
a first locked attitude wherein the working face's longitudinal axis is extending substantially parallel to the handle;
a second locked attitude wherein the working face's longitudinal axis extends substantially perpendicular to the handle, or
a third locked attitude wherein the working face's normal axis extends substantially parallel to the handle.

17. The multi-axis articulated implement of claim 16, comprising:
a forwardly biased actuation tab mounted on the distal end portion for maintaining the at least one plunger in one of the plurality of recesses, whereby the implement is unlocked by using the tab to pull the plunger out of the one of the plurality of recesses.

18. The multi-axis articulated implement of claim 16, comprising:
two diametrically opposed buttons on each side of the distal end portion, for pushing two corresponding plungers in two corresponding recesses, whereby the implement is unlocked.

19. The multi-axis articulated implement of claim 16, wherein:
the at least one plunger is molded into an internal face of the distal end portion, the implement further comprising a sleeve capable of sliding on the distal end portion for pushing the at least one plunger into one of the plurality of recesses, whereby the implement is locked.

20. The multi-axis articulated implement of claim 16, comprising:
a spring inserted into one of the plurality of recesses for forward biasing the at least one plunger and for maintaining the at least one plunger into the at least one plunger holding portion.

21. The multi-axis articulated implement of claim 16, comprising:
a brush on the working face of the end effecter; and
a scraper on the proximal end of the handle portion.

22. A lockable articulated joint comprising:
a first member having a ball shaped attachment, a ridge being provided about a periphery of the ball, the ridge having a non-circular, rotationally symmetric shape; and
a second member adapted to pivotally receive the ball shaped attachment and comprising a conforming recess adapted for nesting of the ridge;
whereby user selectable alignment of the conforming recess with the ridge is for configuring the lockable articulated joint in one of at least two selectable locked positions.

23. The lockable articulated joint of claim 22, comprising:
a plurality of ridges provided about the periphery of the ball;
whereby alignment of one of the plurality of ridges with the conforming recess is for configuring the lockable articulated joint in one of a plurality of selectable locked positions.

24. The lockable articulated joint of claim 22, comprising:
a plurality of conforming recesses provided on the second member;
whereby alignment of the ridge with one of the plurality of conforming recesses is for configuring the lockable articulated joint in one of a plurality of selectable locked positions.

25. The lockable articulated joint of claim 22, wherein:
the ridge has beveled rounded edges;
whereby applying a torque between the first member and the second member is for moving the lockable articulated joint out of the locked position.
